(19) United States
(12) Patent Application Publication
(10) Pub. No.: US 2006/0179043 A1
(43) Pub. Date: Aug. 10, 2006

(54) Information display method and system

(76) Inventors: Shaun William Ryan, Christchurch (NZ); Jamie Glendinning Anstice, Christchurch (NZ); Geoffrey Michael Brash, Christchurch (NZ); Michael Arthur Grantham, Christchurch (NZ); Wayne Alistair Munro, Christchurch (NZ)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/298,975

(22) Filed: Dec. 9, 2005

(30) Foreign Application Priority Data
Dec. 10, 2004 (NZ) 537175

(51) Int. Cl. G06F 17/30

(52) U.S. Cl. 707/3

(57) ABSTRACT

The present invention is adapted to provide an information display method and system. In preferred applications the present invention may be used to optimise the information present within an internet web page to improve the ability of internet search engines to index such content. Other implementations of the present invention may facilitate the identification of particular keywords to be associated with a sponsored search engines results links and bids to be made for such keywords to be submitted to the sponsored search engine.

### CROSS-REFERENCE TO RELATED APPLICATIONS

The present patent application claims priority from New Zealand Patent Application No. 537175, filed on Dec. 10, 2004.

### TECHNICAL FIELD

This invention may be used within an information display method, and to provide a system employed to implement this method. Reference throughout this specification will also be made to the present invention being used to optimise the information present within internet web pages to improve the ability of internet search engines to index such content and also preferably to improve the priority or importance assigned to such content. Reference throughout this specification will also be made to the present invention being used in this application but those skilled in the art should appreciate that a number of alternative applications are also considered.

This invention may also be used as a web page advertising system and method. Preferably the present invention may facilitate the identification of particular keywords to be associated with a sponsored search engine results links and also to facilitate or assist in the selection of a bid value for such sponsored links and the text to be presented for a sponsored link.

### BACKGROUND ART

Providers of internet web pages generally wish to maximise the number of visitors to their sites. High volumes of traffic through a site can increase advertising revenue to the site operator, or alternatively boost the business operations of the site operator through advertising their goods and services.

The majority of traffic directed to websites is generally sourced from search engines. Search engine based web pages can receive from a user a number of key words, and then subsequently display to the user a list of ranked web page addresses for pages which contain content relevant to the search key words entered. Search engines generally operate by running search “spiders”, or software agents which traverse URL (universal resource location) links displayed on web pages and return indications of the content of each page with its associated URL or address.

Web page content providers prefer to have their site assigned a high priority or rank when search results containing a link to their page or pages are displayed to users. The higher a pages priority or page rank, the greater will be its prominence in a page of search results presented. This in turn increases the probability of a user clicking through to the content provider's site and generating the traffic required.

The calculation of priority or page rank by search engines is commonly held as proprietary information by each search engine operator. However, in general terms page rank (as calculated by the search engine Google) can be promoted by increasing the number of links pointing to a page.

It would be of advantage to have an improved information display method and system which allowed web page content to be easily indexed and searched by users. In particular web based content pages which could be optimised to improve the priority or page rank assigned to the content by a search engine, and which also allowed a page to be listed as part of the search results generated by a search engine from a wide range of input key words would also be of advantage.

In the case of search engine providers a revenue stream can be generated through giving priority to search results from an advertiser. In return for a fee, advertiser's results or other promotional material may be displayed prominently to a user when search results related to the advertiser's activities, services or products are presented.

A common mechanism employed to determine payments to be made from advertisers is the pay per click model, which requires advertisers to bid on specific key words or search terms with the intention that their own results will be displayed with high priority when searches are made that contain those key words or search terms.

The pay per click model works well with large numbers of advertisers who provide a revenue stream for the service provider, and in turn are given access to an effective inbound channel for promotional messages to users who are actively searching in the advertiser's domain of interest.

In these instances the search engine's advertisers need to invest a significant amount of time and human resources into bidding on the large number of key words (potentially in the order of tens to hundreds of thousands) which could be used by the targeted audience. These advertisers have limited feedback as to which keywords to bid on from the large set of keywords available, and also have limited ability to determine the relationship between their site traffic sources and volumes, and the keyword bidding strategy they employ. Due to the potentially massive numbers of relevant keywords involved it is not economic for some advertisers to use the pay per click model in these applications.

Furthermore, this problem is compounded when the actual text of such sponsored or advertiser results links needs to be generated. Again the advertiser must ensure that the text presented to a potential customer is relevant to their original query and entices the customer to click through to the advertiser's web page. The effective drafting of such advertising text again results in the need for a significant amount of time and human resource to be invested.

One alternative model or mechanism by which the content of paying advertisers may be promoted is through the paid inclusion model. An advertiser opting for paid inclusion will have the on-line or internet based information they present subjected to detailed analysis by the indexing processes of the search engine involved. The detailed indexing of an advertiser's web site will in turn increase the priority or page rank assigned to results returning a link to a page of the advertiser's web site.

However, the paid inclusion model again is subject to a number of problems and disadvantages.

There is no guarantee offered to advertisers that their search results will be presented to a user or potential customer, and no guarantee that their search results will appear with higher priority than that of their competitors. The advertiser is required to pay for a service which is difficult for them to measure the value of. The pay per click model discussed above at least provides advertisers with an indication as to what their competitors are willing to bid and pay on particular keywords.

Users of the search engine involved may also be presented with a large quantity of results which aren't relevant to the information the user is seeking. Relevant or useful results may be buried in a number of less relevant paid inclusion results which a user must wade through find content of interest. This behaviour of the search engine can deter its users from employing it, as the search engine does not effectively provide relevant search results in a usable format.

Furthermore, the paid inclusion model does not allow an advertiser to prioritise some elements of their content above other less relevant content. An advertiser's entire web site will be indexed and mixed into the search results to be presented, irrespective the relevance of particular pages to the target audience.

It would be of advantage to have a web page advertising system which addressed any or all of the above problems. In particular a system which allowed for the generation of sponsored or advertiser links, and which could facilitate the selection of particular keywords which an advertiser can bid on to advertise would be of advantage.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand, the United States or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a method of displaying information within a web page, characterised by the steps of:
i) displaying an initial web page, and
ii) recording at least one key word used with a search facility to provide a link to the initial web page, and
iii) integrating said at least one recorded key word into the content of the initial web page, and
iv) displaying the updated web page.

According to a further aspect of the present invention there is provided a method of displaying information within a web page, wherein a key word is recorded from a site specific search facility.

According to another aspect of the present invention there is provided a method of displaying information within a web page substantially as described above wherein a key word integrated into the initial web page includes a link to the results of a site search facility, said results having been generated using said key word.

According to a further aspect of the present invention there is provided computer executables instructions adapted to facilitate a method of displaying information within a web page, said computer executable instructions being adapted to execute the steps of;
(i) displaying an initial web page, and
(ii) recording at least one key word used with a search facility to provide a link to the initial web page, and
(iii) integrating said at least one recorded key word into the content of the initial web page, and
iv) displaying the updated web page.

According to another aspect of the present invention there is provided an information display system adapted to implement a method of displaying information substantially as described above.

According to one aspect of the present invention there is provided a method of advertising a web page, characterised by the steps of:
(i) displaying an initial web page, and
(ii) recording at least one key word used with a search facility to provide a link to the initial web page, and
(iii) advertising the web page using said at least one recorded keyword.

According to yet another aspect of the present invention there is provided a method of advertising a web page substantially as described above, wherein the web page is advertised through submitting at least one bid for a recorded keyword to a bid based keyword search engine service.

According to yet another aspect of the present invention there is provided a method of advertising a web page substantially as described above, wherein at least one bid is submitted to an internet wide bid based keyword search engine.

According to a further aspect of the present invention there is provided a method of advertising a web page, wherein a key word is recorded from a site specific search facility.

According to yet another aspect of the present invention there is provided computer executable instructions adapted to facilitate a method of advertising a web page, said instructions being adapted to execute the steps of;
(i) displaying an initial web page, and
(ii) recording at least one key word used with a search facility to provide a link to the initial web page, and
(iii) advertising the web page using said at least one recorded keyword.

According to another aspect of the present invention there is provided an information display system adapted to implement a method of advertising a web page substantially as described above.

The present invention is preferably adapted to provide a method of displaying information. Preferably the information involved may be formatted as electronic files adapted to be read by an internet or web browser. Reference throughout this specification will also be made to the information displayed in conjunction with the present invention being formatted as a web page. Such information is available through internet connections to a wide number of users.

The present invention is adapted to provide a method of displaying information, preferably through web pages. The first step of this method may be to display an initial web page with content which may be of interest to users of web browsers. An initial posting of a web page will allow standard search engine indexing techniques and search spiders to traverse the basic content of the page, and therefore allow the search engine to present an address or URL to the initial web page and a set of results to be presented to a searching user.

In a preferred embodiment a search facility (such as a site specific, or an internet search engine) may be employed to receive key words from a searching user. Such key words may be characteristic of or distinctive with respect to a particular type of content of interest to a searching user.

In a preferred embodiment a keyword as recorded by the present invention includes at least one individual word.

In a preferred embodiment a recorded keyword may be considered by a user of the search facility to be characteristic of the content of the initial web page.

In a preferred embodiment a keyword is recorded when a user of a search facility selects a search result of the search facility to load the web page.

In a preferred embodiment a record may be made of a key word which is used by a searching user to obtain a set of search results including a link to the initial web page posted. In a further preferred embodiment a recording may only be made of particular key words of interest if the initial web page link displayed in the search results is selected and clicked through by a searching user. Preferably such recordings may provide a set of key words which a number of users have employed to search for the content of the initial web page, and where these users have also validated the relevance of a key word through clicking through or visiting the initial web page provided.

In a preferred embodiment the present invention may employ a search facility to obtain a record or recording of a number of key words which searching users have employed to link to or reach the initial web page display. Reference throughout this specification will also be made to the search facility employed being site specific search engine functionality. This type of search engine may be employed by a site operator (and in particular the poster of the initial web page) to allow users to search an entire collection of web pages making up a site. The operator of the site involved may therefore have access to search log files generated by such a facility, which in turn record a list of key words searching users have employed to link to or reach the initial web page displayed.

Reference throughout this specification will also be made to the search facility employed in conjunction with the present invention being a site specific search engine function. However, those skilled in the art should appreciate that other types of search facilities may also be used in conjunction with the present invention and reference to the above only throughout this specification should in no way be seen as limiting.

Preferably the present invention may use key words entered by searching users to define or characterise the content present in the initial web page to be displayed. Such key words as referenced throughout this specification may consist of single words, phrases made up of collections of words together, single characters symbols, or alternatively sets of individual words entered in separate search operations added together as a phrase. Those skilled in the art should appreciate that the exact form or definition of such key words will be dictated by the search facility employed in conjunction with the present invention. Reference throughout this specification will also be made to key words being formed from individual language words, but again those skilled in the art should appreciate this should in no way be seen as limiting.

In a preferred embodiment, once a recording of at least one key word is made the initial web page may be updated. The key word or preferably set of key words recorded may be integrated into the content of the initial web page. This will in turn generate or provide an updated web page for subsequent display in conjunction with the present invention.

The integration of such key words into the content of an initial web page may promote more effective searching of the page and its subsequent discovery and display as a result by a search facility such as a search engine. For example, in a preferred embodiment the integration of such key words into a content based web page can potentially increase the number of times the page is returned as a result by a search engine, irrespective of whether such a search engine is site specific or has an internet wide scope. As the key words integrated into the web page are selected by the target audience of the page, this allows links to the web page displayed to appear in the search results of users with a specific interest in the content of the web page involved. This may in turn facilitate links to the web page involved appearing in more search results and hence generating more traffic for the web page provider.

In a preferred embodiment a recorded keyword integrated into the web page may include a link to a results page of the search facility, said results page having been generated using the recorded keyword integrated into the web page.

In a preferred embodiment a key word integrated into the initial web page may include a web page link. The actual appearance of the key word may preferably be the same as text entered by a user to initially link to the initial web page displayed, while the URL embedded in the key word link may take the user to the results page of a site specific search facility associated with the web site in which the updated web page is integrated.

In a further preferred embodiment the results page which a key word links to may be the result generated by a site specific search facility when the text of the key word integrated is supplied as an input search key word.

This implementation of the present invention can result in the dynamic generation of a results page by a site specific search engine from the provision of a link within the content of a page to be displayed. The dynamic search results generated will in turn incorporate a further link back to the original content web page involved (through the use of the selected key word involved) in addition to links to other pages in the site which may be related to the same selected key word. As can be appreciated by those skilled in the art, the dynamic generation of search results for a site will provide further web pages with additional links to the updated web page displayed, and any other pages in the site linked to the selected key word involved.

If, as in preferred embodiments, a site's pages are configured to allow search engine spiders or agents to traverse the key word links to site specific search results, this will result in the indexing of an additional page for each key word integrated into the updated web page. As can be appreciated by those skilled in the art, the more the search facility involved is employed to generate key words to be associated with a particular web page, the larger the number of site results pages that will be generated to in turn increase the density of links to the updated web page.

In a further preferred embodiment a traffic record may also be maintained of the frequency at which traffic enters the website integrating the updated web page from the dynamically generated results page of an on-site search facility. This record can provide an indication of the additional volume of traffic generated through the method employed in conjunction with the present invention to promote hits or visits to a web site. In some instances such traffic records may be used to implement a business model whereby a service provider who implements the method provided is able to charge a web site provider on the basis of additional traffic generated by the web page or web site involved.

Those skilled in the art should also appreciate however, that the recordings of at least one key word made in association with an initial web page may also be used for other purposes or applications in addition to, or instead of the web page updating system discussed above.

In some embodiments of the present invention the web page involved may be advertised through submitting at least one bid for a recorded keyword to a bid based keyword search engine service.

In a further preferred embodiment a bid may be submitted to an internet wide bid based keyword search engine.

For example, in one embodiment recordings of at least one key word in association with a web page of a site may be used as inputs to a bided key word search engine service. These types of services are generally used to receive manually compiled lists of site addresses and associated key words from the operators of the sites and pages involved. The submitting user also nominates a “bid price” for each page and key word combination. This input key word, page and bid information is then used to display sponsored links or sponsored search results in some types of internet search engines. The bid price specified by a user will determine the priority with which advertising links are displayed on a search results page by the engine in question.

In a preferred embodiment the present may also be used to calculate a bid price for each bid submitted.

In a further preferred embodiment a bid price may be calculated from a sales conversion rate for goods or services offered by the web page to be advertised.

In a preferred embodiment a bid submitted in relation to the present invention may include title text, descriptive text, price text and address information for the web page advertised.

In such embodiments the present invention may be used to automatically input key word and page URL information into a bided search engine service. The present invention may be used to harvest or collate records of key words of particular utility in characterising the pages of a web site to ensure that advertising bids supplied to a bided search engine are placed for the most appropriate key words available.

In a further embodiment of the above, the present invention may also be used to calculate a bid price to be associated with each page URL, and key word list to be submitted. Those skilled in the art should appreciate that the specifics of a business's operation as provided by a site operator should be required as inputs to such a bid value calculation process.

However, those skilled in the art should appreciate that other calculation mechanisms may also be employed, and that reference to the above only throughout this specification should in no way be seen as limiting.

For example, a site operator might sell a FooTronic Plasma TV for $5000, make $2000 for each TV sold, and want to limit the advertising spend for each sale to $200. In this instance the operator also sells a FooTronic CD player for $200, and makes $30 from each sale, and again wants to limit the advertising spend to 10% of this. The operator might know that there are 200 searches for ‘footronic’ per month, 20% of those searches results in a click on this product, and of those 40 clicks per month, 2.5% buy the product. This leads to one sale per 200 searches. From this information it is possible to determine the maximum bid to be made. This search (footronic) has the a sales rate to 1/200 so we can have a maximum bid of advertising spend ($200) multiplied by the sales per search rate ( 1/200), i.e. $1.

The table below shows the rates for several other keywords and the other product.

| Search | | | Clicks to | Sales per | Maximum |
|---|---|---|---|---|---|
| Keyword | Product | Click rate | sales rate | search | bid |
| FooTronic | TV | 20% | 2.5% | 0.5/100 | $1.00 |
| Plasma TV | TV | 30% | 10% | 3/100 | $6.00 |
| FooTronic | TV | 80% | 25% | 20/100 | $40.00 |
| plasma TV | | | | | |
| FooTronic | CD | 40% | 5% | 2/100 | $0.06 |
| CD Player | CD | 10% | 50% | 5/100 | $0.15 |
| Footronic CD | CD | 30% | 50% | 15/100 | $0.45 |

However those skilled in the art should appreciate that a number of different types of bid price calculation formulas may also be used as an alternative to that discussed above. Through the investigation of sales conversion rates, sale margins and pricing applied to goods or services, an advertiser specific bid price calculation algorithm may be customised for individual users of the present invention if required. Furthermore, other factors may also be taken into account if required such as customer preferences and reference to the above in isolation should in no way be seen as limiting.

Furthermore, in some instances the present invention may also be used to assist in the automatic generation of advertising or descriptive text to be submitted in addition to key words as discussed above. In such instances a selection of the content of the page in question may be automatically submitted in addition to any of the information discussed above.

For example, in one preferred embodiment the format of the advertising text to be submitted may consist of a fixed number of lines as in the case of the Google ad words system which uses a four line format. Such advertising text may consist of a title provided as the first line which can be implemented through the text of the key word used to advertise the web page. Two further lines of descriptive text may be drawn from a database of product or service information and may include an appropriate make and/or model for a product in some instances, and the price of a product or service as the follow on line of text. In such instances the last line of the advertising text may consist of a URL providing the link required to the web page advertised.

The present invention may provide many potential advantages over prior art.

The present invention may be used to promote the effective indexing and searching of information presented as web pages or internet sites. The actual audience and users of such content may be employed to select specific key words to be associated with such pages, thereby providing a wider or larger pool of key words which can be used by a search facility to find the web page in question.

In addition the present invention may be used to potentially improve the priority or page rank of a link to the page in question from a search results page. Preferably the present invention may be used to improve the density of links pointing to a particular page and hence therefore improve the priority or importance of the page involved when presented in a set of search engine results.

The present invention may also facilitate a novel business model based on the additional traffic generated to a web site or single web page. Through monitoring whether traffic reaches a web page via dynamically generated search results provided in accordance with the present invention, a service charging business model may be implemented.

The present invention may be used to promote the effective indexing and searching of information presented as web pages or internet sites. The actual audience and users of such content may be employed to select specific key words to be associated with such pages, thereby providing a wider or larger pool of key words which can be used by a search facility to find the web page in question.

The present invention in a number of other instances may also facilitate the automated or semi-automated use of bided key word search engine services. The present invention may be used to record and employ the most relevant key words available for a particular content page and also to potentially calculate a bid price and format the content to be displayed in a bided search results entry.

### BRIEF DESCRIPTION OF DRAWINGS

Further aspects of the present invention will become apparent from the following description which is given by way of example only and with reference to the accompanying drawings in which:

FIG. 1 shows a screen shot of a site search results page provided in accordance with one embodiment, illustrating a number of web pages found relating to the key word “Wanaka”, and

FIG. 2 shows a screen shot of a content based web page found through the Wanaka key word search illustrated in FIG. 1, and

FIG. 3 shows a further site based search engine results web page linked to by the content page discussed with respect to FIG. 2, and

FIG. 4 shows an internet wide search engine results page illustrating a high priority or page count being accorded to the results page of FIG. 3, and

FIG. 5 shows a flow chart of the steps executed to implement the method of the present invention in a preferred embodiment, and

FIG. 6 shows a block schematic flowchart of steps executed in a method of advertising a web page provided in accordance with a further embodiment of the present invention.

### BEST MODES FOR CARRYING OUT THE INVENTION

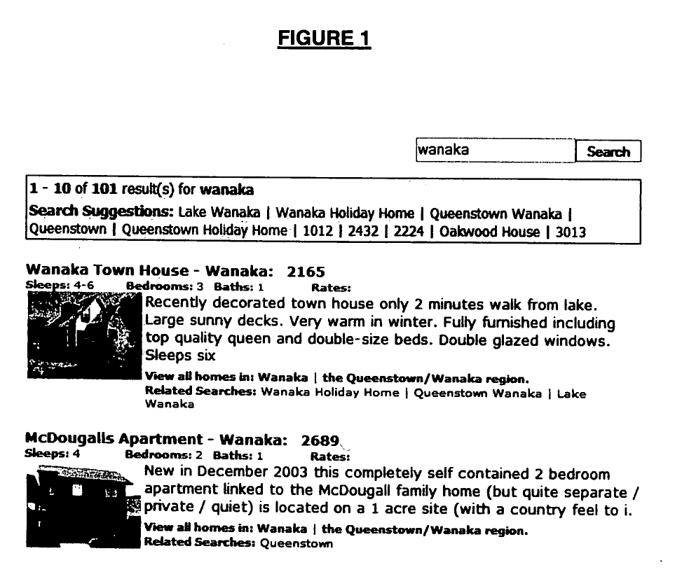

FIG. 1 shows a screen shot of a site search results page illustrating a number of web pages found relating to the key word “Wanaka”.

In the embodiment illustrated with respect to FIG. 1, a results page of a site based search engine facility is illustrated. In this instance the site in question is used to act as a database of holiday homes available for rental in New Zealand. Property numbers 2165 and 2689 are illustrated, where each property also includes a related searches entry, providing links to further on site search results pages. These links are indicated by the key words employed to generate such search results where these key words are also related to the particular property in question.

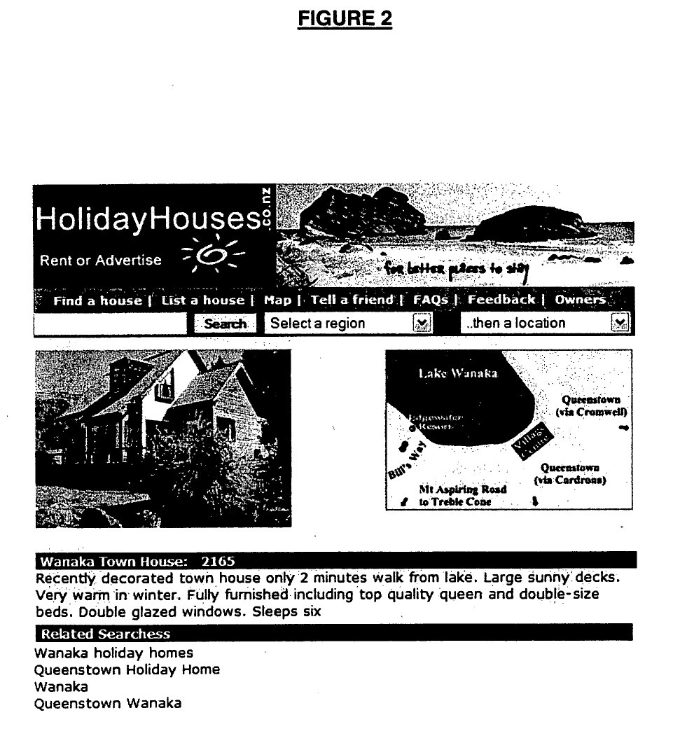

FIG. 2 shows a screen shot of a content based web page found through the “Wanaka” key word search illustrated in FIG. 1.

FIG. 2 shows the content based web page for property number 2165 as linked to the search results discussed with respect to FIG. 1. This content page shows further details of the property in question in addition to a related search entry at the bottom of the page.

A series of four key word links are provided as related searches, where each of these key words have previously been employed by the users to search for and find the content page associated with property number 2165. Each of the related search links, when browsed, take the user to a further onsite search results page generated through using the key word involved as an input.

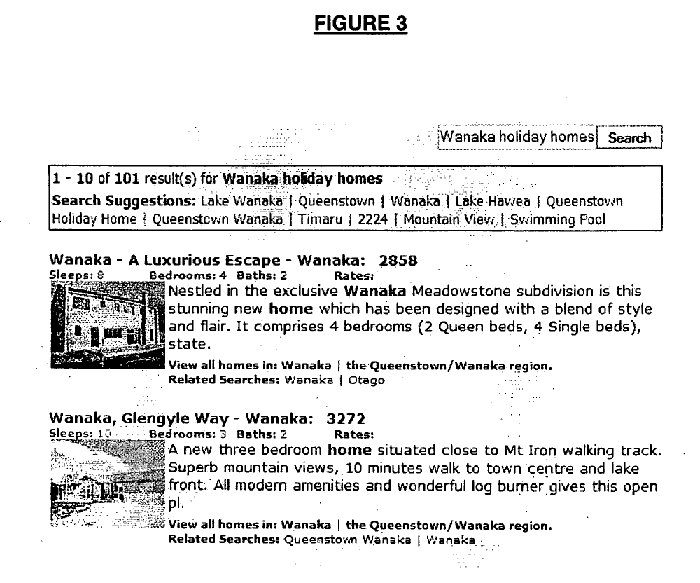

FIG. 3 shows a further site based search engine results web page linked to by the content page discussed with respect to FIG. 2.

FIG. 3 shows the onsite search results generated through the input key words “Wanaka holiday homes”. This page of search results is dynamically generated through a user clicking through on the related search link for “Wanaka holiday homes” as shown on the content web page for property number 2165.

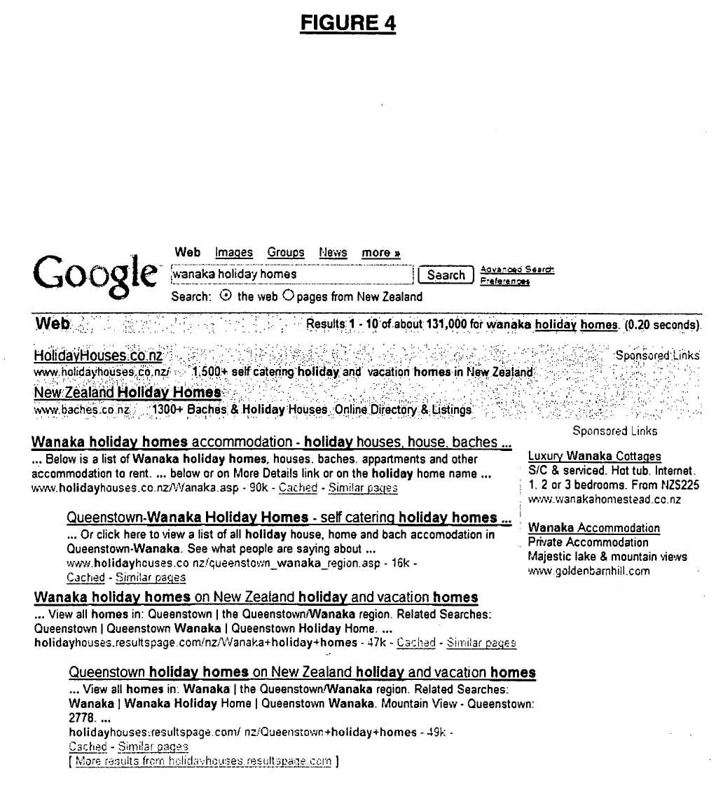

FIG. 4 shows an internet wide search engine results page illustrating a high priority or page count being accorded to the results page of FIG. 3.

As can be seen from FIG. 4 the page rank or priority of the onsite search results page shown with respect to FIG. 3 is comparatively high in the general internet based subject matter search, provided using the search engine Google. Due to content web pages (such as that discussed with respect to FIG. 2) including further links to such dynamically generated site specific search results pages, the priority or importance of these pages assigned by internet based search engines may be improved.

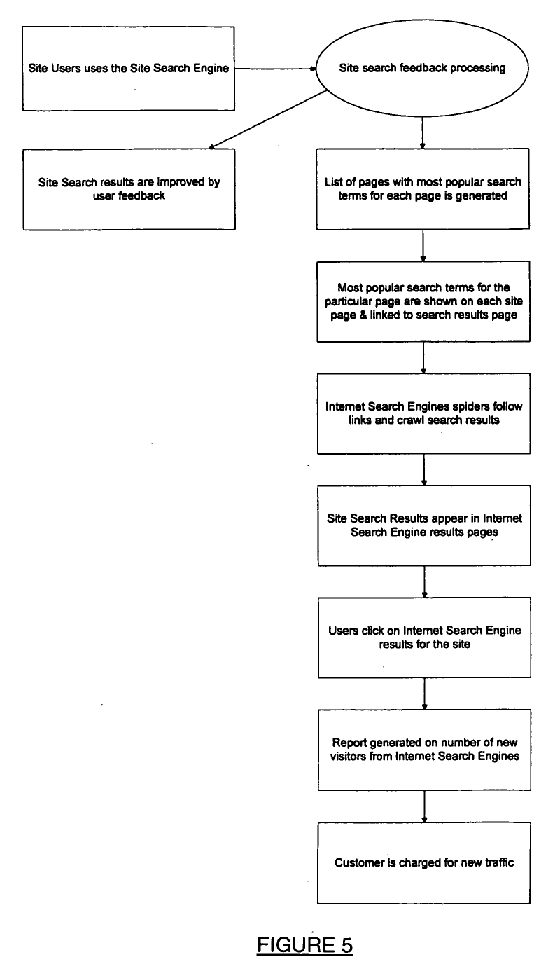

FIG. 5 shows a flow chart of the steps executed to implement the method of the present invention in a preferred embodiment.

The most basic steps in the operation or implementation of the present invention are discussed and illustrated with respect to the first four entries of this flow chart. A site specific search engine is used to obtain information with respect to key words a target audience associates or links to specific content of web pages which can be displayed. The most popular search terms for a page are subsequently displayed on the page and used to link through to a further search results page generated through employing the key words illustrated as input terms.

The site search feedback processing is employed to update each of the content pages with keyword links to dynamically generated search results pages. Each of the pages provided are also written so as to allow internet search engines to follow each of the links presented and crawl through the additional search results pages implemented.

These site based search results then appear on the internet search engines results pages and can be clicked through by searching users to arrive at the web site in question.

Reports can subsequently be generated on the amount of traffic entering a site from search engines through such a site based search results to in turn charge the web site operator for the additional traffic generated through use of the present invention.

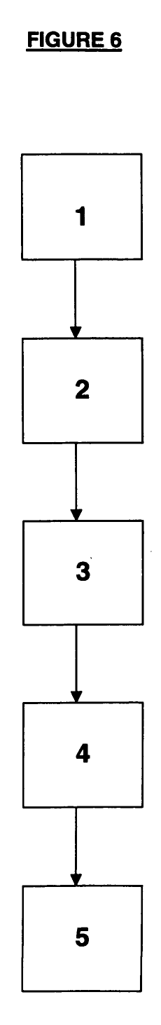

FIG. 6 shows a block schematic flowchart of steps executed in a method of advertising a web page provided in accordance with a further embodiment of the present invention

In the first stage (1) of this method the initial web page to be advertised is displayed, and records or logs are made of the keywords used with a search facility to find and link through to this page. In a preferred embodiment a site specific search engine may be used to present a result link pointing to the web page, where the search logs of this engine can be investigated to identify appropriate keywords for the web page.

At stage (2) of this process the relevant keywords identified are ranked with respect to one another to determine the most popular or commonly used keywords employed to find the web page to be advertised. At this stage a threshold relevance value, such as for example, the top ten percent of keywords can be used to select a set of keywords to advertise the web page involved.

At stage (3) of this process a bid price can be calculated for submission to a bid based search engine in conjunction with one of the top ten percent of the keywords identified in step (2). The bid price calculated can be determined by multiplying an advertiser's advertising budget per sale by the rate of sales made per search completed using the bid based search engine.

At step (4) of this process a text description of the content of the web page to be advertised can be generated and associated with the keyword to be bid on and the bid price calculated.

In a preferred embodiment this process may prepare four lines of descriptive advertising text, consisting of a title plus two descriptive lines and a fourth line that provides the URL of the advertised web site.

In such a preferred embodiment the title may be the key word used to advertise the web page involved. The first descriptive line after the title may be retrieved from a product information database and a specific record providing a description of the product available. The next line of descriptive text may consist of the product or service price, and in some instances may also include additional optional text potentially relating to the terms and conditions of sale or supply. As discussed above the last line of the advertising text may consist of the URL of the web page to be advertised.

At the last stage (5) of this process the bid price, advertising text and identified keyword are submitted to a bid based search engine facility. Preferably the bid price selected will prioritise the advertiser's web page in the search results presented to potential customers thereby effectively advertising the web page.

Aspects of the present invention have been described by way of example only and it should be appreciated that modifications and additions may be made thereto without departing from the scope thereof as defined in the appended claims.

What is claimed:

1. A method of displaying information within a web page, comprising:
(i) displaying an initial web page,
(ii) recording at least one key word used with a search facility to provide a link to the initial web page,
(iii) integrating said at least one recorded key word into the content of the initial web page, and
(iv) displaying the updated web page.

2. A method of displaying information as claimed in claim 1 wherein a key word includes at least one individual word.

3. A method of displaying information as claimed in claims 1 wherein a recorded key word is considered by a user of a search facility to be characteristic of the content of the initial web page.

4. A method of displaying information as claimed in claim 1 wherein a keyword is recorded when a user of a search facility selects a search result of the search facility to load the web page.

5. A method of displaying information as claimed in claim 1 wherein at least one keyword is recorded from a site specific search facility.

6. A method of displaying information as claimed in claim 1 wherein a recorded keyword integrated into the web page includes a link to a results page of the search facility, said results page having been generated using the recorded keyword integrated into the web page.

7. Computer executable instructions adapted to facilitate a method of displaying information within a web page, said instructions being adapted to execute:
(i) displaying an initial web page,
(ii) recording at least one key word used with a search facility to provide a link to the initial web page,
(iii) integrating said at least one recorded key word into the content of the initial web page, and
(iv) displaying the updated web page.

8. Computer executable instructions as claimed in claim 7 wherein a key word includes at least one individual word.

9. Computer executable instructions as claimed in claims 7 wherein a recorded key word is considered by a user of a search facility to be characteristic of the content of the initial web page.

10. Computer executable instructions as claimed in claim 7 wherein a keyword is recorded when a user of a search facility selects a search result of the search facility to load the web page.

11. Computer executable instructions as claimed in claim 7 wherein at least one keyword is recorded from a site specific search facility.

12. Computer executable instructions as claimed in claim 7 wherein a recorded keyword integrated into the web page includes a link to a results page of the search facility, said results page having been generated using the recorded keyword integrated into the web page.

13. A method of advertising a web page, comprising:
(i) displaying an initial web page,
(ii) recording at least one key word used with a search facility to provide a link to the initial web page,
(iii) advertising the web page using said at least one recorded keyword.

14. A method of advertising a web page as claimed in claim 13 wherein a key word includes at least one individual word.

15. A method of advertising a web page as claimed in claims 13 wherein a recorded key word is considered by a user of a search facility to be characteristic of the content of the initial web page.

16. A method of advertising a web page as claimed in claim 13 wherein a keyword is recorded when a user of a search facility selects a search result of the search facility to load the web page.

17. A method of advertising a web page as claimed in claim 13 wherein at least one keyword is recorded from a site specific search facility.

18. A method of advertising a web page as claimed in claim 13 wherein the web page is advertised through submitting at least one bid for a recorded keyword to a bid based keyword search engine service.

19. A method of advertising a web page as claimed in claim 18 wherein at least one bid is submitted to an internet wide bid based keyword search engine.

20. A method of advertising a web page as claimed in claim 18 wherein a bid price is calculated for each bid submitted.

21. A method of advertising a web page as claimed in claim 20 wherein a bid price is calculated using a sales conversion rate for goods or services offered by the web page to be advertised.

22. A method of advertising a web page as claimed in claim 18 wherein a bid submitted includes title text, descriptive text, price text and address information for the web page advertised.

23. Computer executable instructions adapted to facilitate a method of advertising a web page, said instructions being adapted to execute:
(i) displaying an initial web page,
(ii) recording at least one key word used with a search facility to provide a link to the initial web page, and
(iii) advertising the web page using said at least one recorded keyword.

24. Computer executable instructions as claimed in claim 23 wherein a key word includes at least one individual word.

25. Computer executable instructions as claimed in claims 23 wherein a recorded key word is considered by a user of a search facility to be characteristic of the content of the initial web page.

26. Computer executable instructions as claimed in claim 23 wherein a keyword is recorded when a user of a search facility selects a search result of the search facility to load the web page.

27. Computer executable instructions as claimed in claim 23 wherein at least one keyword is recorded from a site specific search facility.

28. Computer executable instructions as claimed in claim 23 wherein the web page is advertised through submitting at least one bid for a recorded keyword to a bid based keyword search engine service.

29. Computer executable instructions as claimed in claim 28 wherein at least one bid is submitted to an internet wide bid based keyword search engine.

30. Computer executable instructions as claimed in claims 28 wherein a bid price is calculated for each bid submitted.

31. Computer executable instructions as claimed in claim 30 wherein a bid price is calculated using a sales conversion rate for goods or services offered by the web page to be advertised.

32. Computer executable instructions as claimed in claim 28 wherein a bid submitted includes title text, descriptive text, price text and address information for the web page advertised.
